(19) United States
(12) Patent Application Publication
(10) Pub. No.: US 2023/0032916 A1
(43) Pub. Date: Feb. 2, 2023

(54) TEST STRIPS TO ANALYZE MONOETHYLENE GLYCOL SOLUTIONS

(71) Applicant: CHEVRON U.S.A. INC., San Ramon, CA (US)

(72) Inventor: Mark Charlesworth, Woodvale (AU)

(73) Assignee: CHEVRON U.S.A. INC., San Ramon, CA (US)

(21) Appl. No.: 17/388,294

(22) Filed: Jul. 29, 2021

(51) Int. Cl. G01N 21/77

(52) U.S. Cl. CPC G01N 21/77; G01N 2021/7759

(57) ABSTRACT

The instant application pertains to a process for improving or managing the recycling of monoethylene glycol from an oil and gas operation with more efficient and cost-effective monitoring. The process comprises repeatedly testing an aqueous solution comprising monoethylene glycol using a test strip to obtain results for various known parameters. The results can be calibrated versus the known parameters to determine an adjustment to the test strip result.

### FIELD OF THE INVENTION

The present inventions are directed to analyzing aqueous monoethylene glycol (MEG) solutions for various properties and chemicals using, for example, test strips.

### BACKGROUND AND SUMMARY

Monoethylene Glycol (MEG) is used in oil and gas application to prevent the formation of hydrates (ice like hydrocarbon/water structures). In facilities where MEG is used it is often required in very large volumes (e.g. >1500 m³/day) and hence to be commercially viable the MEG is often regenerated by techniques such as distillation and/or vacuum reclamation.

The processes of recycling the MEG may be conducted in various ways. One example way is in a closed loop where MEG is injected to the wells regenerated at a host facility to certain specifications that may vary depending upon the application, and then reinjected to the wells. In these situations, it is usually prudent to manage the accumulation of chemical contaminants such as calcium, iron, sulphate, chloride etc. as well as undertake routine monitoring of certain variables such as pH, hardness, and/or alkalinity. This ensures that MEG remains on the desired specifications for use.

Currently this analysis is often undertaken using complex analytical techniques such as Inductively Coupled Plasma, Ion Chromatography, Electrochemical pH probes, etc. Unfortunately, the use of such techniques is often a burden on operations (large number of highly qualified analysts required), OPEX (costly to run and maintain equipment) and CAPEX (large laboratory facilities need to be designed into these facilities. Moreover, due to the sophisticated nature of these analytical techniques, turnaround time on analysis can also be 1-4 days (or if required to be sent onshore for analysis a turnaround can be greater than about 3 weeks). This can lead to a delay in operations response time to significant well production events such as, for example, formation water breakthrough.

What is needed are analytical techniques suitable for MEG solutions that may be conducted by field personnel and/or that do not require expensive/complex equipment and/or that provide faster turnaround than those conventionally used. Advantageously, the instant application addresses one or more up to all of the aforementioned needs and may offer even additional advantages.

It has been discovered that the level of accuracy and limit of detection provided by the aforementioned highly sophisticated analytical techniques may often exceed the needs of an MEG system. The present application pertains in one embodiment to testing an aqueous solution comprising monoethylene glycol using a test strip to obtain a result. This may be employed in, for example, a process for recycling monoethylene glycol from an oil and gas operation. In such an operation the process for recycling monoethylene glycol may be adjusted based on the result.

Alternatively or additionally, the test strip may be used in a process for testing monoethylene glycol solutions. Such processes may involve testing an aqueous solution comprising monoethylene glycol using a test strip to obtain a result for a certain known parameter. A second aqueous solution comprising monoethylene glycol may be tested using a second test strip to obtain a second result for a second certain known parameter. The results may then be calibrated versus certain known parameters to determine an adjustment to the test strip result. In this manner meaningful and useful results may be obtained to adjust parameters or understand trends even if the strip does not exhibit the precision and/or accuracy of traditional more expensive and lengthy testing.

In other embodiments test strips may be used to qualitatively understand trends of certain contaminants in MEG solutions and/or respond more quickly to changes in MEG chemistry so as to avoid, for example, fouling or other deleterious effects to a process or system. In some embodiments, an optical sensor may be employed to scan the test strip, record a result, and/or recommend an adjustment based on the result. The optical sensors may comprise a smartphone camera in some embodiments.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings.

FIG. 1 shows a graph for chloride strips measured values versus actual values.

FIG. 2 shows a graph of hardness strips measured values versus actual values.

### DETAILED DESCRIPTION

Exemplary embodiments of the invention will now be described in order to illustrate various features of the invention. The embodiments described herein are not intended to be limiting as to the scope of the invention, but rather are intended to provide examples of the components, use, and operation of the invention.

The present application relates to the discovery that the level of level of accuracy and limit of detection provided by the aforementioned highly sophisticated analytical techniques may often exceed the needs of an MEG system or process and that certain test strips may be available to be used, modified, and/or calibrated for employment in measuring certain properties and/or chemicals of an MEG solution—particularly those used in, for example, oil and gas applications.

The properties or chemicals to be measured by a test strip or other immediate analytical technique are not particularly limited. Suitable properties or chemical include, but are not limited to, a metal, hardness, chlorine, sulfate (SO₄), bicarbonate (HCO₃), acetic acid (CH₃CO₂H), propionic acid (C₂H₅CO₂H), methyldiethanolamine (MDEA), pH, or any combination thereof. Similarly, the metal is not particularly limited and may include, for example, Na, K, Mg, Ca, Sr, Ba, Fe, or any combination thereof.

Suitable test strips are in some embodiments commercially available and may be modified as needed for use in the present application. Similarly, suitable test strips may be calibrated such that their results are applicable for aqueous solutions comprising, for example, monoethylene glycol. In these manners more convenient, less expensive, and/or faster analytical methods may be employed.

Advantageously, the methods described herein may be applied to, for example, processes for recycling monoethylene glycol from an oil and gas operation. Such processes may comprise testing an aqueous solution comprising monoethylene glycol using a test strip to obtain a result; and adjusting the process for recycling monoethylene glycol based on the result. That is, it may be applied in some embodiments to new wells being put online or formation water breakthrough. In such new wells and formation water breakthrough it is often desirable to diagnose issues quickly and respond which cannot be accomplished via traditional analytical chemistry. Often in such situations analytes such as calcium, magnesium, or other ions may need to be identified either quantitatively or qualitatively so any issues may be remedied via chemical injection or other means. Otherwise, problems such as fouling or corrosion may occur on distillation, heating, or other equipment.

If desired, an optical sensor may be employed to facilitate scanning the test strip which scan may record a result so that a processor may recommend an adjustment based on the result. In some embodiments the optical sensor may comprise a smartphone camera. Other processes may also employ such optical sensors and/or smartphone camera. For example, a process for testing monoethylene glycol solutions may comprise testing an aqueous solution comprising monoethylene glycol using a test strip to obtain a result for a certain known parameter. A second aqueous solution comprising monoethylene glycol may be tested using a second test strip to obtain a second result for a second certain known parameter. The results may then be calibrated versus certain known parameters to determine an adjustment to the test strip result. In this manner commercially available test strips may advantageously be employed in aqueous MEG solutions to reduce and/or eliminate the need for certain more expensive and time consuming analytical tests using expensive equipment.

### EXAMPLES

### Example 1—Chlorine Strips Vs. Actual in 60% Water 40% MEG, Ambient Conditions

| Actual | Strip |
|---|---|
| 523 | 465 |
| 597.5 | 564 |
| 914.2 | 806 |
| 4160 | 3914 |
| 914 | 806 |

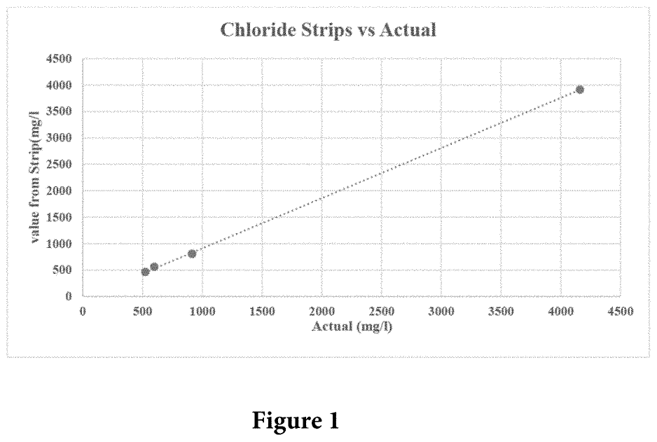

These are shown plotted in FIG. 1.

### Example 2—Hardness in 60% Water 40% MEG, Ambient Conditions

| Actual | Strip |
|---|---|
| 7.5 | 25 |
| 11 | 25 |
| 26 | 50 |
| 180 | 250 |
| 26.1 | 50 |

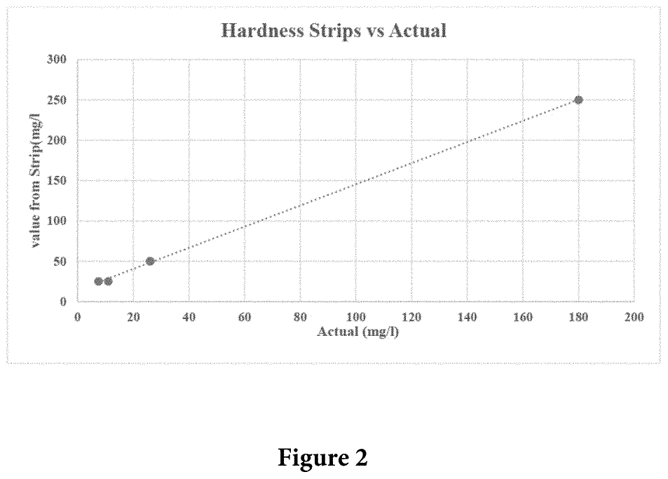

These are shown plotted in FIG. 2.

### Examples 3-12

Various commercially available test strips were used to test aqueous monoethylene glycol compositions for various metals, hardness, chlorine, sulfate (SO₄), bicarbonate (HCO₃), acetic acid (CH₃CO₂H), propionic acid (C₂H₅CO₂H), methyldiethanolamine (MDEA), and pH. The tests were conducted according to the kit instructions at ambient conditions. The test strips employed were colorimetric, 250-1500 mg/L (K) available from Sigma-Aldrich; colorimetric, 10-100 mg/L (Ca2+), MQuant® available from Sigma-Aldrich; Hach Total Hardness Test Strips, 0-425 mg/L available from Hach.com; Hach Iron Test Strips (Total Dissolved Iron), 0-5 mg/L available from Hach.com; Hach Quantab Chloride test strips, 300-6000 mg/L, 0.05-1.0% NaCl available from Hach.com; colorimetric, 200-1600 mg/L (SO42-), MQuant® available from Sigma-Adrich; Hach Total Alkalinity Test Strips, 0-240 mg/L available from Hach.com; non-bleeding pH 2.0-9.0 2.0-2.5-3.0-3.5-4.0-4.5-5.0-5.5-6.0-6.5-7.0-7.5-8.0-8.5-9.0 MQuant® available from Sigma-Adrich; and non-bleeding pH 0-14 0-1-2-3-4-5-6-7-8-9-10-11-12-13-14 MQuant® available from Sigma-Adrich.

Examples 3-7 comprise 60% water and 40% monoethylene glycol. In examples 3-7 below for original pH measurement, initial test strip reading is 6 pH instead of 8.2 if test strip measurement instruction is followed. A pH probe reading is 8.62 pH. After pH adjustment to 9 with addition of sodium hydroxide, test strip reading is 6.5 which does not agree to probe reading (9.0). The Total alkalinity measurement is done before pH adjustment. All other measurement is done after pH adjustment.

Examples 8-12 comprise 70% water and 30% monoethylene glycol with 50 mM methyldiethanolamine. In examples 8-12 below pH was adjusted from 10.5 to 7.7 by adding hydrochloric acid. All measurements were done after pH adjustment.

### Example 3-60% Water/40% MEG

| (60% water/40% MEG-Internal Reference 1) | | | | | |
|---|---|---|---|---|---|
| Salts | Target | Measured | difference | Difference | |
| (mg/L) | (mg/L) | (mg/L) | (mg/L) | (%) | Notes |
| Na | 128.9 | | | | |
| K | 350.7 | 250 | −100.7 | −28.7 | |
| Mg | 0.3 | | | | |
| Ca | 2.5 | 0 | −2.5 | −100.0 | |
| Sr | 0.1 | | | | |
| Ba | 0.2 | | | | |
| Fe | 0.0 | 0 | 0.0 | 0.0 | |
| Hardness | 7.5 | 25 | 17.5 | 233.3 | |
| Cl | 176.0 | | | | |
| Cl | 523.1 | 465 | −58.1 | −11.1 | |
| (corrected) | | | | | |
| SO4 | 50.2 | <200 | | NA | |
| HCO3 | 221.4 | 180 | −41.4 | −18.7 | Tested before |
| | | | | | pH adjustment |
| CH3COOH | 205.8 | | | | |
| C2H5COOH | 80.5 | | | | |
| MDEA | 0.0 | | | | |
| pH | 8.2 | 8.52 (probe)/ | | | 6 pH is |
| (original) | | 6.0 (strip) | | | immediate |
| | | | | | reading |
| | | | | | after dipping |
| pH | 4 | 3.99 (probe)/ | | 0.0 | |
| adjusted | | 4.0 (strip) | | | |

### Example 4-60% Water/40% MEG

| (60% water/40% MEG-Internal Reference 2) | | | | | |
|---|---|---|---|---|---|
| Salts | Target | Measured | Difference | Difference | |
| (mg/L) | (mg/L) | (mg/L) | (mg/L) | (%) | Notes |
| Na | 174.5 | | | | |
| K | 352.4 | 250 | −102.4 | −29.0 | |
| Mg | 0.4 | | | | |
| Ca | 3.8 | 0 | −3.8 | −100.0 | |
| Sr | 0.2 | | | | |
| Ba | 0.4 | | | | |
| Fe | 0.0 | 0 | 0.0 | 0.0 | |
| Hardness | 11.0 | 25 | 14.0 | 127.3 | |
| Cl | 238.4 | | | | |
| Cl | 597.5 | 564 | −33.5 | −5.6 | |
| (corrected) | | | | | |
| SO4 | 50.6 | <200 | | NA | |
| HCO3 | 224.8 | 240 | 15.2 | 6.7 | Tested before |
| | | | | | pH adjustment |
| CH3COOH | 219.8 | | | | |
| C2H5COOH | 81.8 | | | | |
| MDEA | 0.0 | | | | |
| pH | 8.2 | 8.69 (probe)/ | | | 6 pH is |
| (original) | | 6.0 (strip) | | | immediate |
| | | | | | reading |
| | | | | | after dipping |
| pH | 4.0 | 3.97 (probe)/ | | 0.0 | |
| adjusted | | 4.0 (strip) | | | |

### Example 5-60% Water/40% MEG

| (60% water/40% MEG-Internal Reference 3) | | | | | |
|---|---|---|---|---|---|
| Salts | Target | Measured | Difference | Difference | |
| (mg/L) | (mg/L) | (mg/L) | (mg/L) | (%) | Notes |
| Na | 368.4 | | | | |
| K | 359.4 | 250 | −109.4 | −30.4 | |
| Mg | 0.7 | | | | |
| Ca | 9.3 | 0 | −9.3 | −100.0 | |
| Sr | 0.7 | | | | |
| Ba | 1.1 | | | | |
| Fe | 0.1 | 0.15 | 0.05 | 50.0 | |
| Hardness | 26.0 | 50 | 24.0 | 92.3 | |
| Cl | 504.0 | | | | |
| Cl | 914.2 | 806 | −108.2 | −11.8 | |
| (corrected) | | | | | |
| SO4 | 52.2 | <200 | | NA | |
| HCO3 | 239.4 | 240 | 0.6 | 0.2 | Tested before |
| | | | | | pH adjustment |
| CH3COOH | 279.2 | | | | |
| C2H5COOH | 87.3 | | | | |
| MDEA | 0.0 | | | | |
| pH | 8.2 | 8.64 (probe)/ | | | 6 pH is |
| (original) | | 6.0 (strip) | | | immediate |
| | | | | | reading |
| | | | | | after dipping |
| pH | 4.0 | 3.93 (probe)/ | | 0.0 | |
| adjusted | | 4.0 (strip) | | | |

### Example 6-60% Water/40% MEG

| (60% water/40% MEG-Internal Reference 4) | | | | | |
|---|---|---|---|---|---|
| Salts | Target | Measured | Difference | Difference | |
| (mg/L) | (mg/L) | (mg/L) | (mg/L) | (%) | Notes |
| Na | 2357.8 | | | | |
| K | 432.2 | 450 | 17.8 | 4.1 | |
| Mg | 4.0 | | | | |
| Ca | 65.6 | 10 | −55.6 | −84.7 | |
| Sr | 5.7 | | | | |
| Ba | 1.2 | | | | |
| Fe | 0.6 | 0.3 | −0.32 | −51.9 | |
| Hardness | 180.0 | 250 | 70.0 | 38.9 | |
| Cl | 3229.9 | | | | |
| Cl | 4160.0 | 3914 | −246.0 | −5.9 | |
| (corrected) | | | | | |
| SO4 | 69.2 | <200 | | NA | |
| HCO3 | 388.8 | >240 | | NA | Tested before |
| | | | | | pH adjustment |
| CH3COOH | 888.8 | | | | |
| C2H5COOH | 143.8 | | | | |
| MDEA | 0.0 | | | | |
| pH | 8.4 | 8.76 (probe)/ | | | 6 pH is |
| (original) | | 6.5 (strip) | | | immediate |
| | | | | | reading |
| | | | | | after dipping |
| pH | 4.0 | 3.97 (probe)/ | | 0.0 | |
| adjusted | | 4.0 (strip) | | | |

### Example 7-60% Water/40% MEG

| (60% water/40% MEG-Internal Reference 5) | | | | | |
|---|---|---|---|---|---|
| Salts | Target | Measured | Difference | Difference | |
| (mg/L) | (mg/L) | (mg/L) | (mg/L) | (%) | Notes |
| Na | 368.4 | | | | |
| K | 359.4 | 250 | −109.4 | −30.4 | |
| Mg | 0.7 | | | | |
| Ca | 9.3 | 0 | −9.3 | −100.0 | |
| Sr | 0.7 | | | | |
| Ba | 1.1 | | | | |
| Fe | 0.07 | 0 | −0.07 | −100.0 | |
| Hardness | 26.1 | 50 | 23.9 | 91.6 | |
| Cl | 504.0 | | | | |
| Cl | 914.2 | 806 | −108.2 | −11.8 | |
| (corrected) | | | | | |
| SO4 | 52.2 | <200 | | NA | |
| HCO3 | 239.4 | 240 | 0.6 | 0.2 | Tested before |
| | | | | | pH adjustment |
| CH3COOH | 279.2 | | | | |
| C2H5COOH | 87.3 | | | | |
| MDEA | 0.0 | | | | |
| pH | 8.2 | 8.62 (probe)/ | | | 6 pH is |
| (original) | | 6.0 (strip) | | | immediate |
| | | | | | reading |
| | | | | | after dipping |
| pH | 9.0 | 9.00 (probe)/ | | 0.0 | |
| adjusted | | 6.5 (strip) | | | |

### Example 8-70% Water/30% MEG/50 mM MDEA

| (70% water/30% MEG/50 mM MDEA-Internal Reference 1a) | | | | | |
|---|---|---|---|---|---|
| Salts | Target | Measured | Difference | Difference | |
| (mg/L) | (mg/L) | (mg/L) | (mg/L) | (%) | Notes |
| Na | 2400.0 | | | | |
| K | 125.0 | 700 | 575.0 | 460.0 | K |
| | | | | | measurement |
| | | | | | is not |
| | | | | | accurate with |
| | | | | | high acetate |
| | | | | | and MDEA |
| Mg | 10.0 | | | | |
| Ca | 1.8 | 0 | −1.8 | −100.0 | |
| Sr | 0.0 | | | | |
| Ba | 0.0 | | | | |
| Fe | 1.0 | 0.3 | −0.70 | −70.0 | |
| Hardness | 46.1 | 50 | 3.9 | 8.5 | |
| Cl | 2600.0 | | | | |
| Cl | 3845.5 | 3549 | −296.5 | −7.7 | |
| (corrected) | | | | | |
| SO4 | 0.0 | <200 | | NA | |
| HCO3 | n/d | | | | |
| CH3COOH | 1800.0 | | | | |
| C2H5COOH | 0.0 | | | | |
| MDEA | 50 mM | | | | |
| pH | 7.7 | 7.66 (probe)/ | | 0.0 | |
| (original) | | 7.5 (strip) | | | |

### Example 9-70% Water/30% MEG/50 mM MDEA

| (70% water/30% MEG/50 mM MDEA-Internal Reference 1b) | | | | | |
|---|---|---|---|---|---|
| Salts | Target | Measured | Difference | Difference | |
| (mg/L) | (mg/L) | (mg/L) | (mg/L) | (%) | Notes |
| Na | 2400.0 | | | | |
| K | 125.0 | 700 | 575.0 | 460.0 | K |
| | | | | | measurement |
| | | | | | is not |
| | | | | | accurate with |
| | | | | | high acetate |
| Mg | 10.0 | | | | and MDEA |
| Ca | 4.0 | 0 | −4.0 | −100.0 | |
| Sr | 0.0 | | | | |
| Ba | 0.0 | | | | |
| Fe | 1.0 | 0.3 | −0.70 | −70.0 | |
| Hardness | 51.7 | 50 | −1.7 | −3.3 | |
| Cl | 2600.0 | | | | |
| Cl | 3849.4 | 3549 | −300.4 | −7.8 | |
| (corrected) | | | | | |
| SO4 | 0.0 | <200 | | NA | |
| HCO3 | n/d | | | | |
| CH3COOH | 1800.0 | | | | |
| C2H5COOH | 0.0 | | | | |
| MDEA | 50 mM | | | | |
| pH | 7.7 | 7.66 (probe)/ | | 0.0 | |
| (original) | | 7.5 (strip) | | | |

### Example 10-70% Water/30% MEG/50 mM MDEA

| (70% water/30% MEG/50 mM MDEA-Internal Reference 1c) | | | | | |
|---|---|---|---|---|---|
| Salts | Target | Measured | Difference | Difference | |
| (mg/L) | (mg/L) | (mg/L) | (mg/L) | (%) | Notes |
| Na | 2400.0 | | | | |
| K | 125.0 | 700 | 575.0 | 460.0 | K |
| | | | | | measurement |
| | | | | | is not |
| | | | | | accurate with |
| | | | | | high acetate |
| | | | | | and MDEA |
| Mg | 10.0 | | | | |
| Ca | 10.0 | 10 | 0.0 | 0.0 | detection |
| | | | | | limit could |
| | | | | | be 10 ppm |
| Sr | 0.0 | | | | |
| Ba | 0.0 | | | | |
| Fe | 0.0 | 0 | 0.00 | 0.0 | |
| Hardness | 66.7 | 50 | −16.7 | −25.0 | |
| Cl | 2600.0 | | | | |
| Cl | 3860.0 | 3549 | −311.0 | −8.1 | |
| (corrected) | | | | | |
| SO4 | 0.0 | <200 | | NA | |
| HCO3 | n/d | | | | |
| CH3COOH | 1800.0 | | | | |
| C2H5COOH | 0.0 | | | | |
| MDEA | 50 mM | | | | |
| pH | 7.7 | 7.66 (probe)/ | | 0.0 | |
| (original) | | 7.5 (strip) | | | |

### Example 11-70% Water/30% MEG/50 mM MDEA

| (70% water/30% MEG/50 mM MDEA-Internal Reference 1d) | | | | | |
|---|---|---|---|---|---|
| Salts | Target | Measured | Difference | Difference | |
| (mg/L) | (mg/L) | (mg/L) | (mg/L) | (%) | Notes |
| Na | 2400.0 | | | | |
| K | 125.0 | 700 | 575.0 | 460.0 | K |
| | | | | | measurement |
| | | | | | is not |
| | | | | | accurate with |
| | | | | | high acetate |
| | | | | | and MDEA |
| Mg | 10.0 | | | | |
| Ca | 1.0 | 0 | −1.0 | −100.0 | |
| Sr | 0.0 | | | | |
| Ba | 0.0 | | | | |
| Fe | 2.0 | 1.0 | −1.00 | −50.0 | |
| Hardness | 44.2 | 50 | 5.8 | 13.1 | |
| Cl | 2600.0 | | | | |
| Cl | 3844.1 | 3549 | −295.1 | −7.7 | |
| (corrected) | | | | | |
| SO4 | 0.0 | <200 | | NA | |
| HCO3 | n/d | | | | |
| CH3COOH | 1800.0 | | | | |
| C2H5COOH | 0.0 | | | | |
| MDEA | 50 mM | | | | |
| pH | 7.7 | 7.66 (probe)/ | | 0.0 | |
| (original) | | 7.5 (strip) | | | |

### Example 12-70% Water/30% MEG/50 mM MDEA

| (70% water/30% MEG/50 mM MDEA-Internal Reference 1e) | | | | | |
|---|---|---|---|---|---|
| Salts | Target | Measured | Difference | Difference | |
| (mg/L) | (mg/L) | (mg/L) | (mg/L) | (%) | Notes |
| Na | 2400.0 | | | | |
| K | 125.0 | 700 | 575.0 | 460.0 | K |
| | | | | | measurement |
| | | | | | is not |
| | | | | | accurate with |
| | | | | | high acetate |
| | | | | | and MDEA |
| Mg | 10.0 | | | | |
| Ca | 1.0 | 0 | −1.0 | −100.0 | |
| Sr | 0.0 | | | | |
| Ba | 0.0 | | | | |
| Fe | 5.0 | 2.0 | −3.00 | −60.0 | |
| Hardness | 44.2 | 50 | 5.8 | 13.1 | |
| Cl | 2600.0 | | | | |
| Cl | 3844.1 | 3549 | −295.1 | −7.7 | |
| (corrected) | | | | | |
| SO4 | 0.0 | <200 | | NA | |
| HCO3 | n/d | | | | |
| CH3COOH | 1800.0 | | | | |
| C2H5COOH | 0.0 | | | | |
| MDEA | 50 mM | | | | |
| pH | 7.7 | 7.66 (probe)/ | | 0.0 | |
| (original) | | 7.5 (strip) | | | |

Examples 3-7 shows that in 60% water/40% MEG mixture
SO₄, HCO₃ and Cl can be measured by test kit or strip within allowed error percentage for all cases
K can be measured by test kit with ˜30% lower than target
Ca and Fe can be measured by test kit or strip with large error
Total hardness measurements have consistent positive bias
At high pH condition (8-9 pH), test strip reading is 6-6.5 pH with large error. However, at pH4, test strip reading is 4 and consistent with probe reading.

Examples 8-12 show that in 70% water/30% MEG/50 mM MDEA/1800 mg/L acetate mixture:
SO₄, Cl and pH can be measured by test kit or strip within allowed error percentage for all cases
K cannot be measured accurately. Measured value is 460% higher than target, which could be due to presence of MDEA and acetate
Ca can be measured accurately at 10 mg/L. But cannot be detected at 1 and 4 mg/L level
Total hardness measurements have consistent positive bias
Fe can be measured by test kit or strip with large error
pH test strip readings are consistent with pH probe reading and within allowed error percentage for all cases

In sum, commercial test strips could be used as is or modified for beneficial use in testing various MEG solutions for various properties and the level of various metals or compounds. For certain ions such a hardness, bicarbonate, chloride, potassium, and iron the test strips may be used qualitatively or alternatively calibrated to respond more accurately in MEG solutions.

What is claimed is:

1. A process for monitoring the recycling of monoethylene glycol from an oil and gas operation comprising:
testing an aqueous solution comprising monoethylene glycol using a test strip to obtain a result; and
adjusting the process for recycling monoethylene glycol based on the result.

2. The process of claim 1 wherein the aqueous solution comprising monoethylene glycol is tested for a metal, hardness, chlorine, sulfate (SO₄), bicarbonate (HCO₃), acetic acid (CH₃CO₂H), propionic acid (C₂H₅CO₂H), methyldiethanolamine (MDEA), pH, or any combination thereof.

3. The process of claim 2 wherein the metal is Na, K, Mg, Ca, Sr, Ba, Fe, or any combination thereof.

4. The process of claim 1 which further comprises employing an optical sensor to scan the test strip, record a result, and recommend an adjustment based on the result.

5. The process of claim 4 wherein the optical sensor comprises a smartphone camera.

6. A process for testing monoethylene glycol solutions comprising:
testing an aqueous solution comprising monoethylene glycol using a test strip to obtain a result for a certain known parameter;
testing a second aqueous solution comprising monoethylene glycol using a second test strip to obtain a second result for a second certain known parameter;
calibrating the results versus certain known parameters to determine an adjustment to the test strip result.
